(19) United States
(12) Patent Application Publication
(10) Pub. No.: US 2012/0056020 A1
(43) Pub. Date: Mar. 8, 2012

(54) Line marker

(76) Inventor: Liam D. Philpotts, Sioux City, IA (US)

(21) Appl. No.: 13/199,463

(22) Filed: Aug. 30, 2011

Related U.S. Application Data
(60) Provisional application No. 61/402,773, filed on Sep. 3, 2010.

(51) Int. Cl. B05B 3/18

(52) U.S. Cl. 239/722; 239/289

(57) ABSTRACT

A line marker includes a first beam (9) and a second beam (13) pivotally attached to the first beam such that the second beam is pivotable about a pivot point (15, 17) relative to the first beam. A spray nozzle (35) is provided on the second beam (13) so as to mark an arcuate line centered on the pivot point of the second beam. The line marker may be incorporated into a mobile line marking apparatus which includes a wheeled chassis (1) provided with apparatus for marking a substantially straight line.

### CROSS-REFERENCE TO RELATED APPLICATION

This application claims the benefit of U.S. Provisional Application No. 61/402,773, filed Sep. 3, 2010, the entire specification of which is hereby incorporated by reference.

### TECHNICAL FIELD

The present invention relates to a line marker, for example for marking arcuate lines on sports fields, and to a mobile line marking apparatus incorporating such a line marker.

### BACKGROUND ART

It is conventional practice by groundsmen to mark arcs, including quadrants and semi-circles, on a sports pitch by hand, either freehand, with or without a marker, or using a stencil.

One form of mobile line marking apparatus is known, for example, from U.S. Pat. No. 6,053,376, which describes a mobile line marking apparatus in the form of an operator's seat mounted on a wheeled chassis (a so-called “ride-on” apparatus). The apparatus is powered and is steerable in order that the operator can follow a predetermined line with a line-marking shoe. The line-marking shoe is mounted on an outrigger provided with a parallelogram linkage which allows the shoe to be moved from an operational configuration to a stowed configuration in which the shoe is moved upwardly and inwardly towards the chassis as a result of the parallelogram linkage. The shoe includes a nozzle which can be positioned in any one of a number of sockets in order to determine the width of the line being marked.

An alternative form of mobile line marking apparatus, in the form of a pedestrian line marking apparatus, is described in US-A-2009 0205 566 in which a line marking head is movable laterally of the chassis so as to compensate for deviations from an intended line being marked.

WO-A-03082418 describes an autonomous ground maintenance vehicle which travels around a sports field under its own power and guided by guidance means provided by an outboard computer. Lines are marked by a nozzle mounted on an arm assembly.

GB-A-2 292 166 describes a manually-operable ground marking instrument which enables an arc or a circle to be marked on the ground. The instrument is provided with a length of line which can extend to a fixed point a distance from the instrument to enable the line to be marked. However, an operator is required to hold the spray nozzle as it is moved along the arc.

WO-A-2010023275 describes a hybrid line marking apparatus which comprises mobile line marking apparatus in the form of both a pedestrian line marking apparatus and a ride-on unit.

There is a therefore problem when marking arcs, such as corner quadrants and semi-circles, on sports pitches. Present means do not permit an accurate line to be marked quickly.

### SUMMARY OF THE INVENTION

According to one aspect of the present invention there is provided a line marker comprising:

a first beam and a second beam pivotally attached to the first beam;
means operable to pivot the second beam about a pivot point relative to the first beam; and
a spray nozzle provided on the second beam so as to mark an arcuate line centered on the pivot point of the second beam.

According to another aspect of the present invention there is provided a mobile line marking apparatus comprising a wheeled chassis provided with means for marking a substantially straight line and with a line marker comprising:

a first beam and a second beam pivotally attached to the first beam;
means operable to pivot the second beam about a pivot point relative to the first beam; and
a spray nozzle provided on the second beam so as to mark an arcuate line centered on the pivot point of the second beam.

Spacer means may be provided on the first beam for spacing the first beam from a body to which the line marker is attached.

The second beam may be pivotally mounted to the first beam by way of a tubular member provided on the first beam and a cylindrical member provided on the second beam and engaging with the tubular member.

The second beam may be provided with a lever arm, for example in the form of a plate, operating means being provided for operating the second beam. The operating means may comprise a hand-operated lever pivotally mounted on the first beam and an operating arm secured at one end thereof to the hand-operated lever and pivotally mounted to the lever arm at the other end thereof. Alternatively, the operating means may comprise an hydraulic cylinder mounted on the first beam and including an operating arm pivotally mounted to the lever arm.

The spray nozzle may be movably mounted on the second beam in order to adjust the radius of the arc to be marked. A flexible pipe, for example coiled around the second beam, may be provided for supplying marking material to the nozzle. A valve may be provided for controlling the supply of marking material to the nozzle.

### BRIEF DESCRIPTION OF THE DRAWINGS

In the drawings:

FIG. 1 is a plan view of one embodiment of a mobile line marking apparatus including one embodiment of an arcuate line marker according to the present invention in a first configuration;

FIG. 2 is a plan view of the arcuate line marker in a second configuration;

FIG. 3 is a perspective view of the arcuate line marker shown in FIGS. 1 and 2; and

FIG. 4 is a perspective view of another embodiment of a line marker for use with the line marking apparatus of FIGS. 1 and 2.

### DESCRIPTION OF PREFERRED EMBODIMENTS

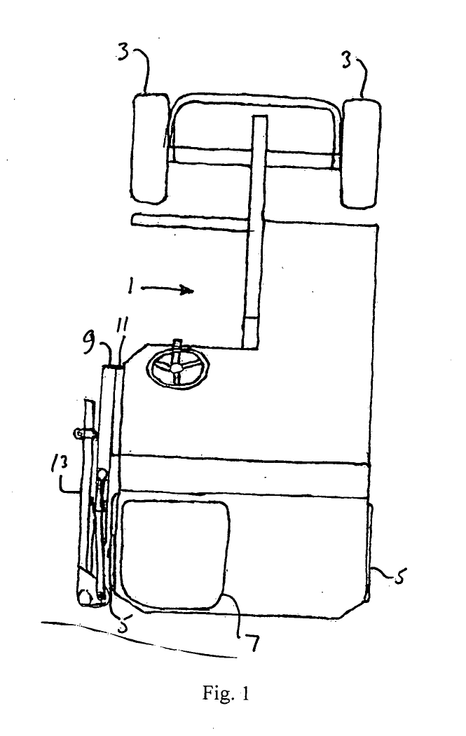

The line marking apparatus shown in FIG. 1 is similar to that of WO-A-2010 023 275 (hereinafter the '275 publication) and the entire content thereof is incorporated herein by reference. However, it should be noted that other forms of mobile line marking apparatus can be used in the present invention including both ride-on and pedestrian apparatus.

The line marking apparatus shown in FIG. 1 comprises a chassis 1 provided with front, steerable wheels 3 and with rear wheels 5. A seat 7 for an operator is mounted on the chassis together with components for marking a substantially straight line as described in the '275 publication.

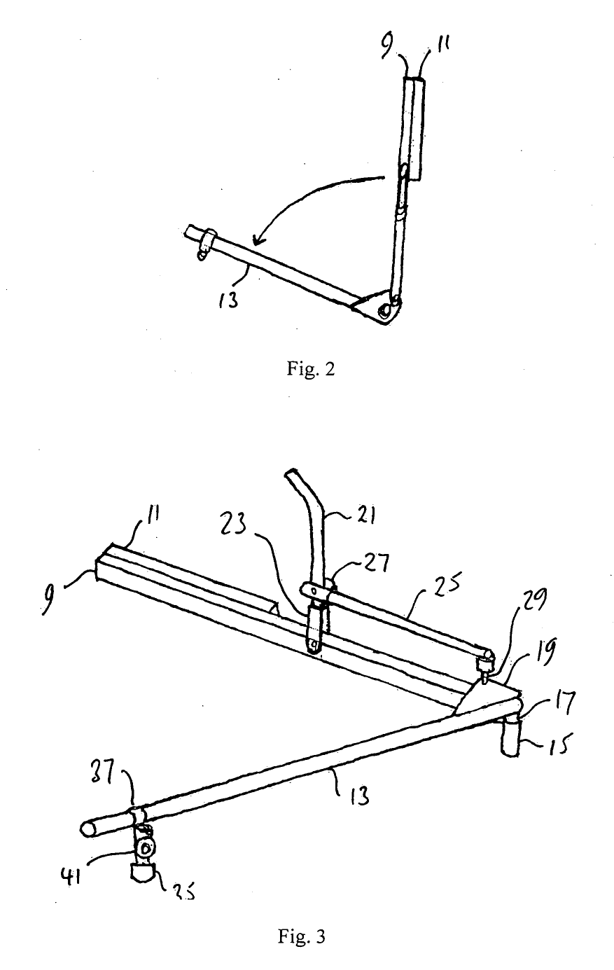

Mounted to one side of the chassis 1, preferably close to the operator's seat 7, is a line marker for marking an arc, including a quadrant or semi-circle. The arcuate line marker is shown in more detail in FIGS. 2, 3 and 4. The arcuate line marker comprises a first beam 9 adapted to be secured to the chassis 1, for example by way of spacer 11 as illustrated in order to space the first beam 9 outwardly of the wheels of the line marking apparatus. The arcuate line marker may be permanently mounted on the line marking apparatus, or may be temporarily mounted thereon. The first beam 9 extends along one side of the chassis, spaced laterally outboard thereof.

A second beam 13 is pivotally mounted to an end region of the first beam, for example in the region of a rear corner of the chassis 1. Pivotal mounting may be achieved by any convenient means, such as a downwardly extending tubular member 15 mounted at an end of the first beam 9 and a downwardly extending cylindrical member 17 mounted at an end of the second beam and engaging in the tubular member 15.

The second beam 13 is provided in the region of the pivotal mounting with a lever arm, for example in the form of a plate 19 secured to the second beam 13 by welding. Operating means for moving the second arm between a closed position, as shown in FIG. 1, and an open position, such as that shown in FIG. 2, is mounted on the first beam 9 and engages with the plate 19.

As shown in FIG. 3, the operating means may comprise in one embodiment a hand-operated lever 21 pivotally mounted on the first beam 9 by way of a stirrup arrangement 23 and an operating arm 25 secured at one end thereof to the hand-operated lever 21 by way of a stirrup arrangement 27 and secured at the other end thereof to the plate 19 by way of a pivot pin 29.

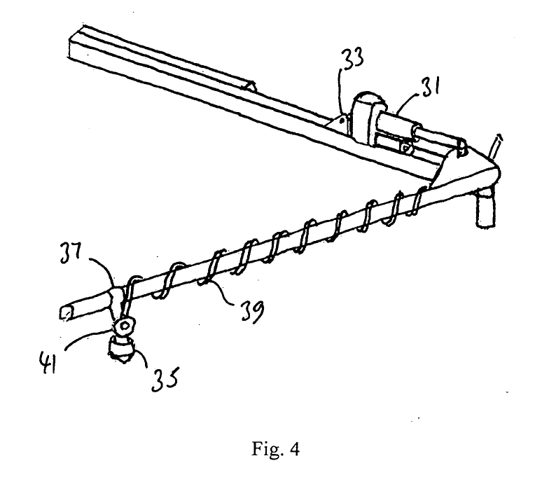

Alternatively, as shown in FIG. 4, the operating means may comprise in another embodiment an hydraulic cylinder 31, an operating arm of which is connected to the plate 19 by way of pivot pin 29 and which is mounted on the first beam 9 by way of a mounting 33 which allows a degree of upward and lateral pivoting motion to compensate for movement of the plate 19 as the second beam 13 is moved. The operating arm of the hydraulic cylinder 31 is extendable and retractable under control of the operator to move the second beam 13 between the closed and open positions. Alternative mechanical means, such as a worm, gear or chain drive, may replace the hydraulic cylinder if desired.

A spray nozzle 35 is mounted on the second beam 13 by way of a mounting 37 which is movable along the beam 13 in order to set the radius of the arc to be marked. Marking material is supplied to the nozzle 35 by any convenient means, such as a flexible pipe 39 which is coiled around the beam 13 as illustrated diagrammatically in FIG. 4 and which is connected to a supply of line marking material (not shown) provided on the line marking apparatus. A valve 41 allows the supply of line marking material to be controlled.

In use of the arcuate line marker forming part of the line marking apparatus shown in FIG. 1, the operator maneuvers the line marking apparatus such that the pivotal mounting 15 is directly above the center of the arc to be marked by the nozzle 35 and the nozzle itself is above a radial line from which the marking is to begin. The nozzle is then adjusted relative to the second beam 13, if necessary, to determine the desired radius of the arc. Of course, if the apparatus is intended only to mark arcs of fixed radius no adjustment is required. The supply of line marking material to the nozzle is then initiated by the user and the second beam 13 is moved, for example manually as described in relation to FIG. 3 or hydraulically as described in relation to FIG. 4, so as to mark the desired arcuate line, the extent of the arc being determined by the operator up to 180 degrees. The amount of line marking material used can be determined both by the speed at which the second beam 13 is moved and by the rate at which material is delivered to the nozzle 35, for example by adjusting the valve 41.

It will be appreciated that although the second beam 13 has been described as being mounted at the end of the first beam 9, a further beam, which may or may not be pivotally mounted to the first beam 9, may be interposed between the first and second beams. In this way the centre of the arc to be marked may be moved away from the line marking apparatus and could, given appropriate arm lengths, allow an arc or more than 180 degrees to be traversed, even up to substantially 360 degrees.

While the above description contains many specifics, those specifics should not be construed as limitations on the scope of the disclosure, but merely as exemplifications of preferred embodiments thereof. Those skilled in the art will envision many other possible variations that are within the scope and spirit of the disclosure as defined by the claims appended hereto.

I claim:

1. A line marker comprising:
a first beam and a second beam pivotally attached to the first beam;
means operable to pivot the second beam about a pivot point relative to the first beam; and
a spray nozzle provided on the second beam so as to mark an arcuate line centered on the pivot point of the second beam.

2. The line marker of claim 1, wherein spacer means is provided on the first beam for spacing the first beam from a body to which the line marker is attached.

3. The line marker of claim 1, wherein the second beam is pivotally mounted to the first beam by way of a tubular member provided on the first beam and a cylindrical member provided on the second beam and engaging with the tubular member.

4. The line marker of claim 1, wherein the second beam is provided with a lever arm, operating means being provided for operating the second beam.

5. The line marker of claim 4, wherein the lever arm is in the form of a plate.

6. The line marker of claim 4, wherein the operating means comprises a hand-operated lever pivotally mounted on the first beam and an operating arm secured at one end thereof to the hand-operated lever and pivotally mounted to the lever arm at the other end thereof.

7. The line marker of claim 4, wherein the operating means comprises an hydraulic cylinder mounted on the first beam and including an operating arm pivotally mounted to the lever arm.

8. The line marker of claim 1, wherein the spray nozzle is movably mounted on the second beam in order to adjust the radius of the arc to be marked.

9. The line marker of claim 8, wherein a flexible pipe is provided for supplying marking material to the nozzle.

10. The line marker of claim 9, wherein the flexible pipe is coiled around the second beam.

11. The line marker of claim 8, wherein a valve is provided for controlling the supply of marking material to the nozzle.

12. A mobile line marking apparatus comprising a wheeled chassis provided with means for marking a substantially straight line and with a line marker comprising:
a first beam and a second beam pivotally attached to the first beam;
means operable to pivot the second beam about a pivot point relative to the first beam; and
a spray nozzle provided on the second beam so as to mark an arcuate line centered on the pivot point of the second beam.

13. The mobile line marking apparatus of claim 12, wherein spacer means is provided on the first beam for spacing the first beam from a body to which the line marker is attached.

14. The mobile line marking apparatus of claim 12, wherein the second beam is pivotally mounted to the first beam by way of a tubular member provided on the first beam and a cylindrical member provided on the second beam and engaging with the tubular member.

15. The mobile line marking apparatus of claim 12, wherein the second beam is provided with a lever arm, operating means being provided for operating the second beam.

16. The mobile line marking apparatus of claim 15, wherein the lever arm is in the form of a plate.

17. The mobile line marking apparatus of claim 15, wherein the operating means comprises a hand-operated lever pivotally mounted on the first beam and an operating arm secured at one end thereof to the hand-operated lever and pivotally mounted to the lever arm at the other end thereof.

18. The mobile line marking apparatus of claim 15, wherein the operating means comprises an hydraulic cylinder mounted on the first beam and including an operating arm pivotally mounted to the lever arm.

19. The mobile line marking apparatus of claim 12, wherein the spray nozzle is movably mounted on the second beam in order to adjust the radius of the arc to be marked.

20. The mobile line marking apparatus of claim 19, wherein a flexible pipe is provided for supplying marking material to the nozzle.

21. The mobile line marking apparatus of claim 20, wherein the flexible pipe is coiled around the second beam.

22. The mobile line marking apparatus of claim 19, wherein a valve is provided for controlling the supply of marking material to the nozzle.
